(19) United States
(12) Patent Application Publication
(10) Pub. No.: US 2021/0164279 A1
(43) Pub. Date: Jun. 3, 2021

(54) DOOR CLOSER ASSEMBLY

(71) Applicant: dormakaba Deutschland GmbH, Ennepetal (DE)

(72) Inventors: Konstantin LYGIN, Ennepetal (DE); Thomas SALUTZKI, Ennepetal (DE); Alexander HELLWIG, Ennepetal (DE); Dennis MEIERING, Ennepetal (DE); Jan-Hendrik JÄHNKE, Ennepetal (DE)

(21) Appl. No.: 17/095,156

(22) Filed: Nov. 11, 2020

(30) Foreign Application Priority Data
Dec. 2, 2019 (EP) 19213005.2

(51) Int. Cl. E05F 3/22; E05F 1/10; E05F 7/00

(52) U.S. Cl. CPC E05F 3/227; E05F 1/1066; E05F 7/00; E05Y 2900/132; E05Y 2201/488; E05Y 2400/44; E05Y 2201/218

(57) ABSTRACT

A door closer assembly includes a door closer without a powered drive for closing a door. The door closer includes an energy accumulator, wherein the energy accumulator is chargeable by manually opening the door and wherein the energy accumulator discharges for closing the door. A sensor unit is also included for detecting an angle information with regard to the opening angle of the door.

### CROSS REFERENCE TO RELATED APPLICATIONS

This application claims priority to and benefit of European Patent Application No. EP 19213005.2, filed Dec. 2, 2019, which is herein incorporated by reference in its entirety.

### TECHNICAL FIELD

The disclosure relates to a door closer assembly with a door closer without powered drive and a method for operating the door closer assembly.

### BACKGROUND

Door closers and door drives for actuating a door are known from the state-of-the-art. Door closers include an energy accumulator, for example a spring. Said energy accumulator is charged, when a user manually opens the door. For closing the door, the energy accumulator is discharged in this case, the spring relaxes, for example. In the state-of-the-art, there are also door closers with an auxiliary powered drive, which assists charging the energy accumulator upon opening the door. However, the door drives have a powered drive. A powered drive does not receive the required energy from the user of the door, but a powered drive has an external supply, for example from a power grid. A door drive can include for example an electric or hydraulic drive as the powered drive, which develops the entire force for opening and/or closing the door. In addition to the powered drive, an energy accumulator can be employed in the door drive.

In the present case are considered door closers without powered drive; namely neither door drives nor door closers with an auxiliary drive.

### SUMMARY

The present disclosure provides a door closer assembly with a door closer without powered drive, which allows for a secure use of a door and a secure operation of a building, in which the door closer assembly is installed.

Within the scope of the disclosure, it was recognized that it could be advantageous in a door closer without powered drive to detect the position the door is located in. Generally, said information is denoted as “angle information with regard to the opening angle of the door”, and for example can comprise the actual opening angle, an indication of an angle dependent on the opening angle, or information such as “open”, “opened”, “partially opened”, etc.

The angle information with regard to the opening angle of the door can be used to verify at a central location (building control unit), for example, whether the door is open or closed. Moreover, a building control unit can use said information, for example, in order to correspondingly control other elements of the building, for example ventilation or smoke extraction.

The disclosure provides a door closer assembly having the features of the independent claim. Advantageous further embodiments of the disclosure are the subject matter of the dependent claims.

Thus, the disclosure specifically provides a door closer assembly comprising a door closer without powered drive, and a sensor unit. The door closer without powered drive is neither a door drive nor a door closer with an auxiliary drive. The door closer without powered drive is formed for closing a door by means of an energy accumulator. Manually opening the door charges and closing the door discharges the energy accumulator. In particular, the energy accumulator is a spring.

The sensor unit of the door closer assembly is disposed and formed for detecting the angle information with regard to the opening angle of the door. In particular for this purpose, it is provided for the sensor unit to measure the angle information not directly at the door, but to be disposed at a corresponding element of the door closer assembly, for example the door closer or the arm assembly, and to detect a rotary or linear movement, respectively position at said location. In turn, based on the known geometry of the entire door closer assembly, said data can be readily recalculated to the corresponding angle information with regard to the opening angle of the door.

Preferably, the door closer assembly includes an interface unit for sending the angle information to a building control unit superordinate to the door closer assembly. The interface unit can be located in the door closer. As an alternative, the interface unit can be disposed as well outside the door closer in the area of the door. Furthermore, the interface unit can comprise several networked components at different positions.

The connection between the interface unit and the building control unit can be cable-bound or cordless. In particular, the building control unit is formed to display the angle information with regard to the opening angle of the door and/or, based on said information, to control another element of the building, for example ventilation or smoke extraction.

Particularly preferred, the door closer assembly comprises a blocking device for holding the door open against the closing force of the door closer, respectively energy accumulator. Said blocking device can be incorporated into the door closer or can be located outside the door closer. For example, the blocking device is an electromagnetic assembly, which holds the door leaf open. The interface unit of the door closer assembly is formed for receiving a closing signal from the building control unit. In response to said closing signal, the interface unit can control the blocking device, whereupon the blocking device cancels said blocking and the closing force of the energy accumulator closes the door.

Preferably, the sensor unit comprises a transmitter and a sensor. In particular, the sensor is formed for contact-less detecting a rotary position, respectively a linear position of the transmitter.

The transmitter can be a self-contained component, which is attached to a corresponding location. Likewise, it is possible to use an element otherwise present or an otherwise present area within the door closer assembly as the transmitter, and to position the sensor correspondingly, in order to detect the position of the transmitter. In particular, the sensor is located on a printed circuit board, wherein preferably other electronical components and/or conductors are disposed on the printed circuit board.

Preferably, the transmitter is a permanent magnet and the sensor is correspondingly formed, in order to detect the position of the permanent magnet. In another alternative, it is possible, for example, for the sensor to optically detect the position of the transmitter.

According to a preferred embodiment, it is provided for the door closer to comprise an output shaft. The sensor unit is disposed at the output shaft for detecting the rotation of the output shaft. In particular, the transmitter is formed at the output shaft or attached to the output shaft. Accordingly, the sensor is disposed at a non-rotating part of the door closer or of the arm assembly.

For example, the output shaft of the door closer is connected to a closer piston of the door closer via a cam contour or via a toothed rack. The closing piston in turn represents the connection to the energy accumulator in the door closer. Thus, the closing piston and the cam contour, respectively the toothing, convert the linear movement of the energy accumulator to the rotary movement of the output shaft. Preferably, in addition to the door closer, the door closer assembly comprises an arm assembly. When the door closer is attached to the door leaf, the aim assembly serves for transmitting force onto the door frame. In the reverse arrangement, the door closer is located at the door frame and the arm assembly transmits the force onto the door leaf. In both variants, there are basically two construction types for the arm assembly: The arm assembly can comprise a rod, the one end thereof being connected to the output shaft of the door closer and the other end to a sliding member. The sliding member in turn slides linearly mobile in a sliding rail. According to the second variant, the arm assembly comprises two rods and is formed as a scissor arm assembly. The two rods are rotatably connected to each other. The free end of the first rod is connected to the output shaft. The free end of the second rod is connected to the door leaf, respectively to the door frame.

Now preferably, it is provided for a first end of the output shaft to be torque-proof connected to the arm assembly of the door closer assembly, and a sensor unit to be disposed at the opposite second end of the output shaft. Said second end of the output shaft is “not used” and therefore can be well used for placing the sensor unit.

In particular, it is provided for the transmitter to be formed at or attached to the second end of the output shaft. Thus, the transmitter rotates with the output shaft. Accordingly, the sensor is disposed at a non-rotating part of the door closer.

Particularly preferred, it is provided for the door closer to include a door closer covering. In particular, the door closer comprises a door closer housing, for example from cast metal. The closer piston and the dampening piston are linearly mobile guided in said door closer housing. Said door closer housing is disposed in the door closer covering, for example made from sheet metal or plastic material. Preferably, the herein used door closer covering has a recess at the second end of the output shaft and thus includes a hole. Preferably, a sensor cover closes said recess, wherein the sensor is mounted to the inside of the sensor cover. In particular, the sensor is located on the printed circuit board, wherein the printed circuit board is mounted to the inside of the sensor cover.

Preferably in turn, the sensor cover is disposed at the door closer covering or at a separate sensor cover frame. When using the sensor cover frame the same is disposed at the door closer covering and surrounds the recess. Preferably, the connection between the sensor cover and the door closer covering, respectively between the sensor cover and the sensor cover frame is formed such that the sensor cover is linearly mobile displaceable. By correspondingly displacing the sensor cover, the second end of the output shaft is free and the transmitter can be mounted to the front side of the output shaft. By displacing the sensor cover with the printed circuit board disposed thereat including the sensor, the sensor is positioned at the desired location.

According to a further variant, preferably it is provided for the sensor unit to be disposed at the first end of the output shaft. As already described, the first end of the output shaft is torque-proof connected to the arm assembly of the door closer assembly. Accordingly, the sensor unit can be disposed at the connection of the output shaft to the rod. In particular, it is provided herein for the sensor to be attached to the first end of the output shaft or to the rod; thus, the sensor rotates with the output shaft, respectively with the rod. Correspondingly, the transmitter is disposed at a non-rotating part of the door closer in the area of the connection of the output shaft to the rod.

As already described, the arm assembly can be formed as a scissor arm assembly and, in this case, comprises two rods rotatable to each other. Accordingly, the sensor unit can be disposed at the connection of the two rods for detecting the rotation between the two rods. With known geometry of the door closer assembly, detecting the angle between the two rods allows for directly determining the angle information with regard to the opening angle of the door. In this case, the sensor is in particular torque-proof disposed at the one rod and the transmitter is formed at or attached to the other rod.

In the event no scissor arm assembly is used, but a rod with a sliding member in a sliding rail, in particular the following advantageous embodiments are provided:

The sensor unit is disposed at the connection of the rod to the sliding member for detecting the rotation between the rod and the sliding member. Preferably in this case, the transmitter is formed at or attached to the rod. Accordingly, the sensor is located at or in the sliding member. Also, the reverse arrangement is possible.

The sliding member is linearly mobile guided in the sliding rail such that when moving the door, the rod always rotates in relation to the sliding member. Consequently, the detected rotation between the rod and the sliding member allows for determining the angle information with regard to the opening angle of the door.

Moreover preferably, it is provided for the sensor unit to be disposed in the sliding rail and to thereby detect the position of the sliding member in relation to the sliding rail. Upon opening the door, the sliding member moves linearly in the sliding rail. The position of the sliding member in the sliding rail allows for determining the angle information with regard to the opening angle of the door.

Thus herein, the linear position of the sliding member is detected in the sliding rail. This can be realized for example as follows:

Preferably, the sensor unit comprises a tensioning element windable to and un-windable from a spindle. The tensioning element is disposed such that it can be wound up and unwound when moving the sliding member, wherein the sensor unit is formed for detecting the rotation of the spindle. Detecting the rotation of the spindle allows for directly drawing conclusions as to the position of the sliding member in the sliding rail. Said linear position in turn allows for directly determining the angle information with regard to the opening angle of the door.

According to a preferred embodiment, the spindle, on which the tensioning element winds up and unwinds from, is rotatably supported in the sliding rail. Accordingly, the free end of the tensioning element is attached to the sliding member. Herein again, the reverse arrangement is possible, wherein the spindle is rotatably supported in the sliding member, and the end of the tensioning element is attached to an end of the sliding rail.

Preferably, herein a helical spring is provided, which is disposed for winding up the tensioning element.

Preferably, the transmitter is formed at or attached to the spindle and thus rotates with the spindle. Accordingly, the sensor is disposed at a non-rotating area next to the transmitter.

With the intention to accommodate the tensioning element as safely as possible in the sliding rail, preferably it is provided for the sliding rail to include at least two channels. In particular, the sliding rail is an extruded profile, which includes at least said two channels. The sliding member is guided in the first channel. The tensioning element extends in the second channel. Preferably, a slot connects the two channels to each other. The connection between the tensioning element and the sliding member passes through said slot.

However, it is also possible to detect the linear position of the sliding member in the sliding rail without the tensioning element. For this purpose, the tensioning element is formed as a linear sensor unit, which is disposed along the guide of the sliding member in the sliding rail. In particular, the linear sensor unit comprises a preferably magnetic transmitter in the sliding member and one or more sensors at the sliding rail. For example, the sensor comprises several conducting paths, which extend along the sliding rail and allow for a position detection of the transmitter. In particular, the sensor is formed for this purpose as a film sensor, wherein the conducting paths are incorporated into a film.

Furthermore, the disclosure comprises a method for operating a door closer assembly, in particular of the above-described door closer assembly. In the method a sensor unit detects angle information with regard to the opening angle of the door at a door closer without powered drive. The described advantageous embodiments and dependent claims for the door closer assembly find corresponding advantageous application in the inventive method.

In particular, it is provided for the detected angle information to be sent to a superordinate building control unit. Preferably, the building control unit displays the angle information and/or, based on the angle information, controls another element of the building, for example ventilation or smoke extraction. Furthermore, preferably based on the angle information, it is provided for the building control unit to control the door closer assembly, for example a blocking device.

### BRIEF DESCRIPTION OF THE DRAWINGS

The disclosure is now described in more detail based on exemplary embodiments. In this case, it shows:

FIG. 1 an inventive door closer assembly according to a first exemplary embodiment,

FIG. 2 a sectional view of a door closer of the inventive door closer assembly according to the first exemplary embodiment,

FIG. 3 a detail of the inventive door closer assembly according to the first exemplary embodiment,

FIG. 4 another detail of the inventive door closer assembly according to the first exemplary embodiment,

FIG. 5 an inventive door closer assembly according to a second exemplary embodiment,

FIG. 6 a detail of the inventive door closer assembly according to the second exemplary embodiment,

FIG. 7 another detail of the inventive door closer assembly according to the second exemplary embodiment,

FIG. 8 an inventive door closer assembly according to a third exemplary embodiment,

FIG. 9 a detail of the inventive door closer assembly according to the third exemplary embodiment,

FIG. 10 another detail of the inventive door closer assembly according to the third exemplary embodiment,

FIG. 11 an inventive door closer assembly according to a fourth exemplary embodiment,

FIG. 12 a detail of the inventive door closer assembly according to the fourth exemplary embodiment,

FIG. 13 another detail of the inventive door closer assembly according to the fourth exemplary embodiment,

FIG. 14 a diagrammatic view of a sliding rail of the inventive door closer assembly according to the fourth exemplary embodiment, and

FIG. 15 a diagrammatic view of an inventive door closer assembly according to a fifth exemplary embodiment.

### DETAILED DESCRIPTION OF THE DRAWINGS

In the following are described door closer assemblies 1 of different exemplary embodiments. Same, respectively functionally same parts are identified with the same reference numerals in all exemplary embodiments. The same door closer 2 can be employed in all exemplary embodiments.

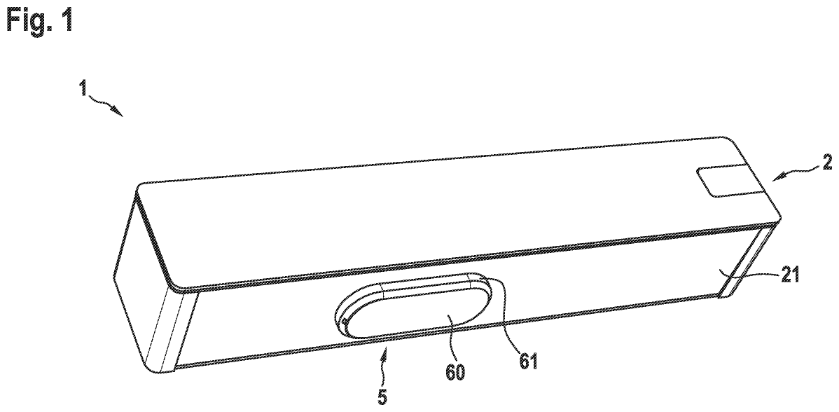

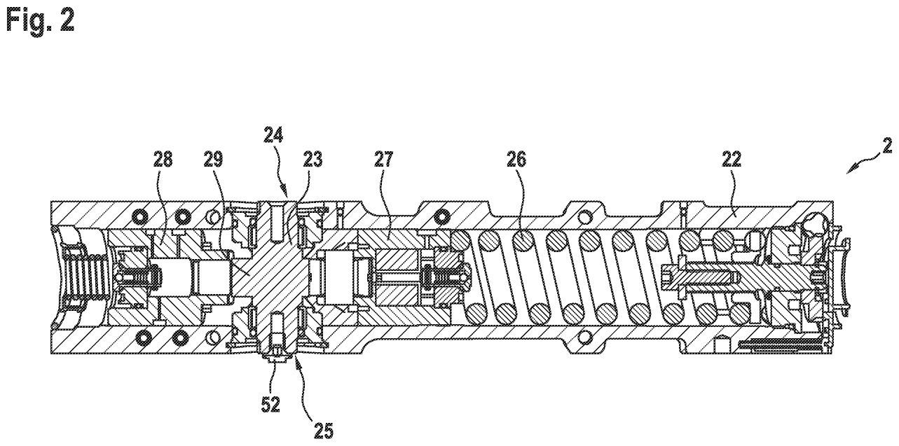

By way of example, the door closer 2 for all exemplary embodiments is described based on the first exemplary embodiment and FIGS. 1 and 2. The door closer 2 comprises a door closer covering 21, for example made from plastic material or from sheet metal. A door closer housing 22, for example a cast part, is located inside the door closer covering 21. An output shaft 23 is rotatably mobile supported in the door closer housing 22. The output shaft 23 includes a first end 24 and a second end 25. The output is realized via the first end 24, for example via an arm assembly 4.

An energy accumulator 26, herein formed as a spring, is located inside the door closer housing 22. A closing piston 27 and a dampening piston 28 are linearly mobile guided in the door closer housing 22. Both pistons 27, 28 roll on a cam contour 29 of the output shaft 23. Thereby, a conversion is possible between linear and rotary movement and between the pistons 27, 28 and the output shaft 23.

Opening the door causes a rotation of the output shaft 23 and tensioning the energy accumulator 26 by means of a movement of the closing piston 27. When closing the door, the energy accumulator 26 relaxes and thereby moves the output shaft 23 via the closing piston 27.

In each exemplary embodiment, the door closer assembly 1 comprises a sensor unit 5. The sensor unit 5 is disposed such as to detect the movement of a component of the door closer assembly 1, whereby angle information can be determined with regard to the opening angle of the door.

Preferably, in all exemplary embodiments, it is provided for the sensor unit 5 to comprise a sensor 51 and a transmitter 52. The transmitter 52 is formed as a permanent magnet with two opposing poles. In this case, the transmitter axis 57 of the transmitter 52, which connects the two poles to each other, is thereby preferably always vertical to the axis of rotation 58. Correspondingly, the sensor 51 is disposed above or below the transmitter 52 such that the axis of rotation 58 extends through the sensor 51. Preferably, transmitter axis 57 and axis of rotation 58 are vertical to each other.

In all exemplary embodiments, preferably, the sensor 51 is disposed on a printed circuit board 53. Preferably, the door closer assembly 1 comprises an interface unit 54. Preferably, said interface unit 54 is likewise located on the printed circuit board 53.

In the exemplary embodiments shown, the interface unit is connected to the building control unit 55 via an optional cabling 56. Instead of the cabling 56, also a cordless connection can be used between the interface unit 54 and the building control unit 55.

In the first exemplary embodiment according to the FIGS. 1 to 4, the transmitter 52 is located at the front side at the second end 25 of the output shaft 23. Thus, the transmitter 52 rotates with the output shaft 23.

FIG. 1 shows the exterior door closer covering 21. In the sectional illustration according to FIG. 2, the door closer covering 21 is omitted. The arrangement of the sensor 51 is not shown either herein for the sake of clarity.

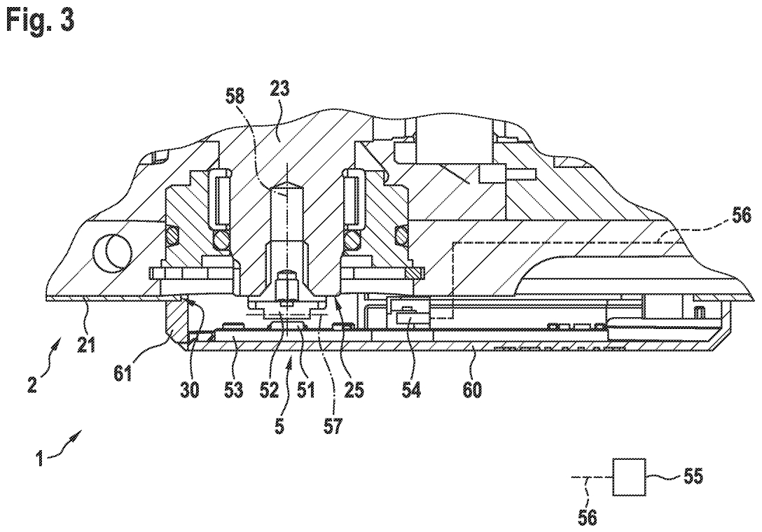

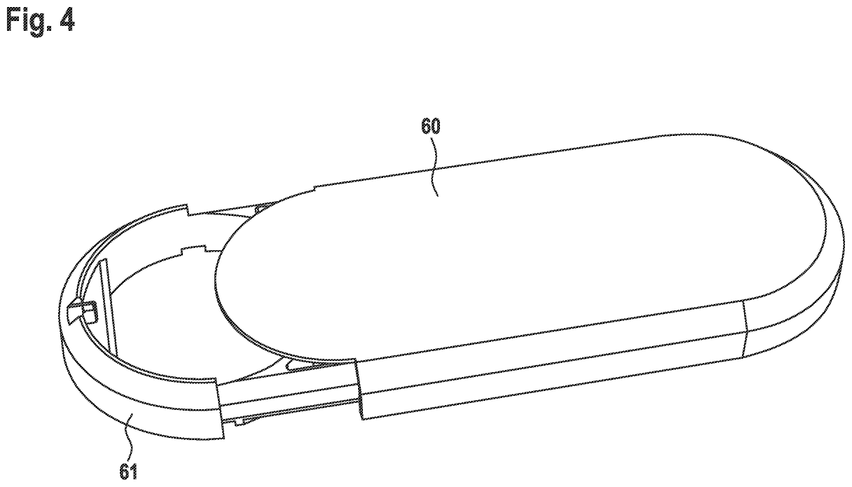

As in particular shown in the illustration of FIG. 3, the door closer covering 21 has a recess 30. A sensor cover 60 closes said recess 30. The sensor cover 60 is linearly displaceably disposed on a sensor cover frame 61. The sensor cover frame 61 in turn is attached to the door closer covering 21 such that the sensor cover frame 61 surrounds the recess 30 and the sensor cover 60 closes the recess. FIG. 4 shows the sensor cover frame 61 with the sensor cover 60 in the opened location.

The printed circuit board 53 with the sensor 51 is disposed on the inside of the sensor cover 60.

The cabling 56 extends from the interface unit 54 through the recess 30 into the inside of the door closer covering 21.

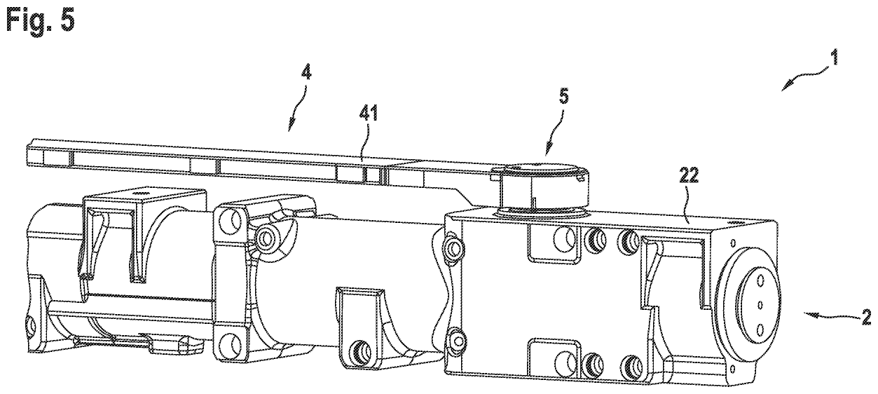

In the second exemplary embodiment shown in the FIGS. 5 to 7, the first end 24 of the output shaft 23 is torque-proof connected to a rod 41 of the arm assembly 4. Said rod 41 can be the rod of a scissor arm assembly or can be connected to a sliding member 42.

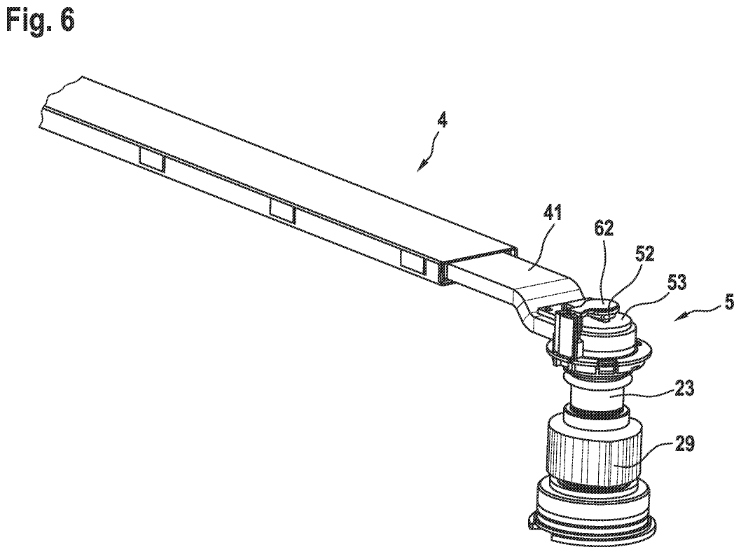

For this purpose, FIG. 6 just shows the output shaft 23 of the door closer 2 and the end of the rod 41 attached thereto. A covering of the rod 41 is omitted. As in particular shown in FIG. 6, the sensor unit 5 comprises a cantilever arm 62. The cantilever arm 62 is torque-proof connected to the door closer 2; for example to the door closer housing 22. Thereby, the cantilever arm 62 does not rotate with the output shaft 23, respectively with the rod 41. The transmitter 52 is located at the cantilever arm 62.

The sensor 51 is located opposite the transmitter 52. Herein, the sensor 51 is firmly connected to the rod 41. In particular for this purpose, it is provided for the printed circuit board 53, which carries the sensor 51, to be disposed on the rod 41.

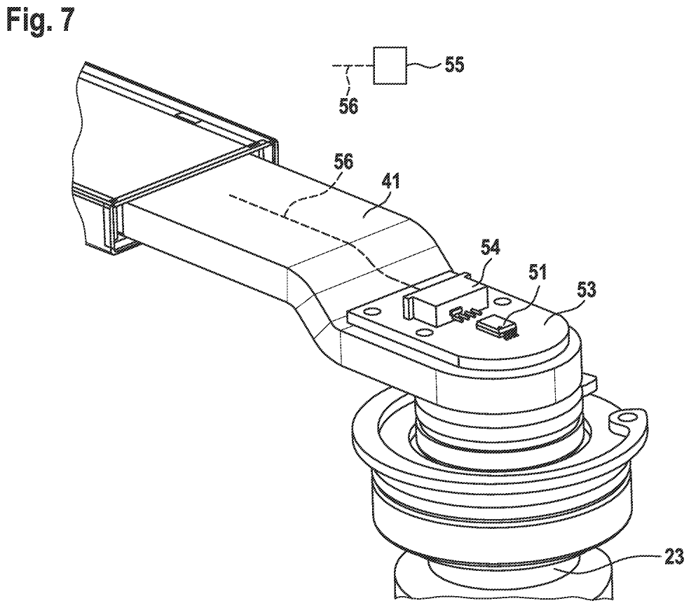

FIG. 7 shows the arrangement without the cantilever arm 62 and the transmitter 52. In this case, it is diagrammatically drawn in that the cabling 56 can extend from the interface unit 54 through the rod 41 or along the rod 41.

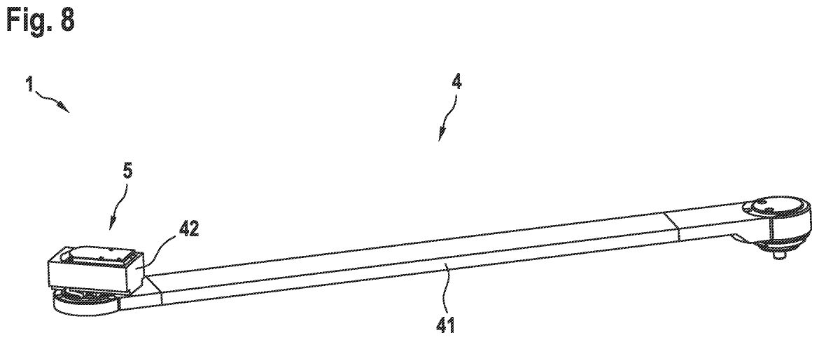

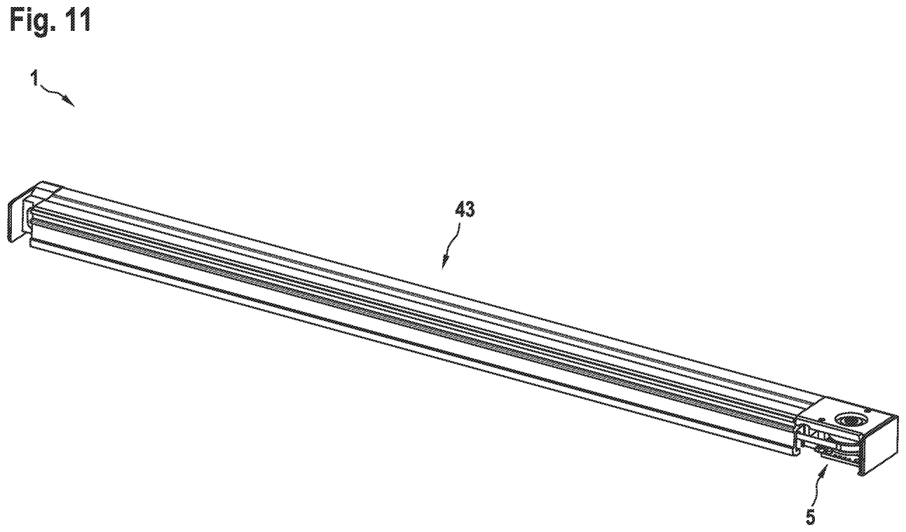

For the third exemplary embodiment, FIGS. 8 to 10 show the embodiment of the arm assembly 4 with the rod 41 and the sliding member 42. Said sliding member 42 is guided in a sliding rail 43, for example shown in FIG. 11. Herein, the sensor unit 5 is located at the connection between the rod 41 and the sliding member 42.

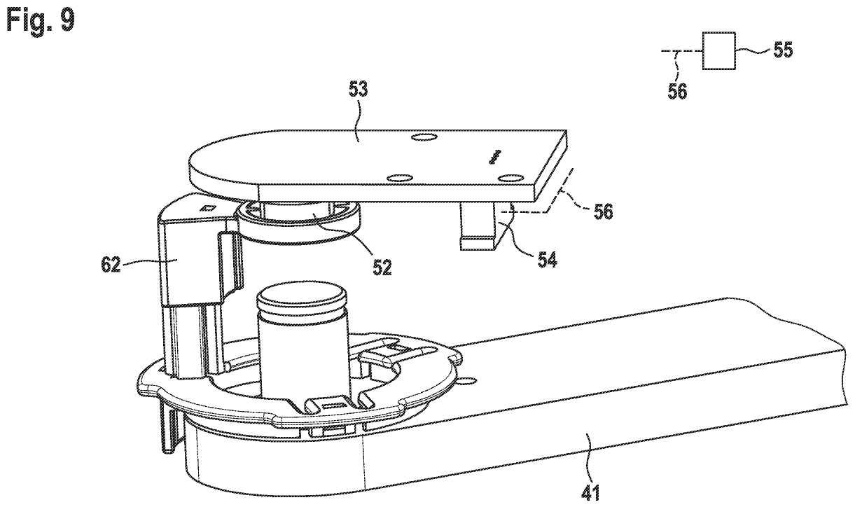

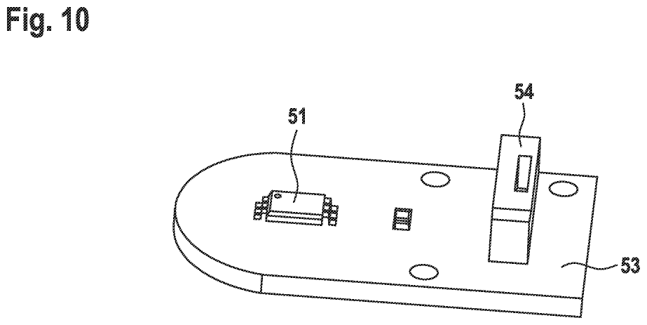

FIG. 9 shows the inside of the sliding member 42. A sliding housing of the sliding member 42 is omitted. FIG. 10 shows the underside of the printed circuit board 53. According to said Figures, the sensor unit 5 in turn comprises a cantilever arm 62, which is torque-proof connected to the rod 41 and carries the transmitter 52. The sensor 51 is disposed opposite the transmitter 52. Via the printed circuit board 53, the sensor 51 is disposed firmly in the sliding member 42.

In the fourth exemplary embodiment, corresponding to the FIGS. 11 to 14, the sensor unit 5 is disposed in the sliding rail 43.

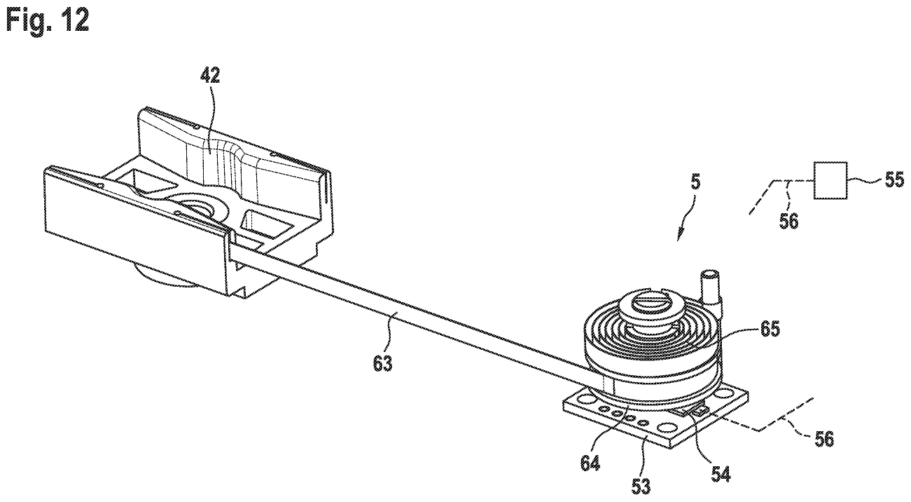

FIG. 11 shows the sliding rail 43, in which the sliding member 42 is linearly mobile guided, as shown in FIG. 8 for example. In FIG. 12 the profile of the sliding rail 43 is omitted such as to reveal the structure of the sensor unit 5.

The sensor unit 5 comprises a tensioning element 63, which is disposed windable to and un-windable from a spindle 64. A helical spring 65 is provided for winding up the tensioning element 63.

The free end of the tensioning element 63 is connected to the sliding member 42. When moving the sliding member 42 in the sliding rail 43, the tensioning element 63 is wound up and unwound such that the spindle 64 rotates.

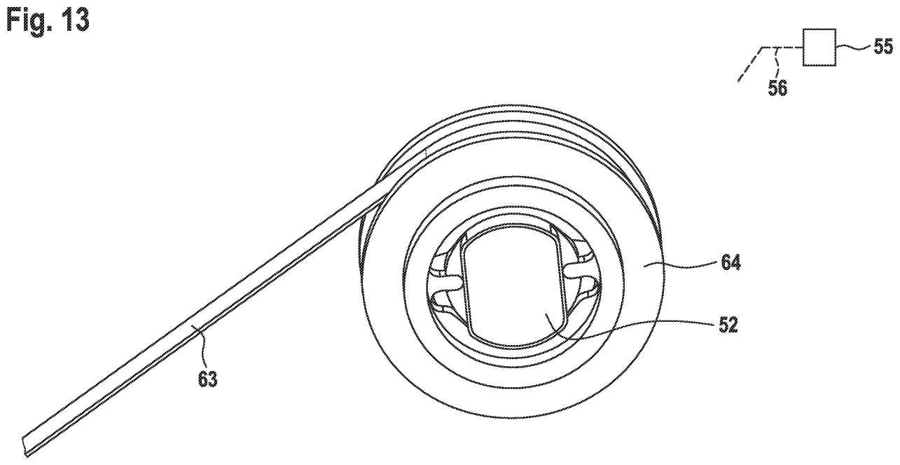

As shown in FIG. 13, the transmitter 52 is located at a frontal end of the spindle 64 and thus rotates with the spindle 64.

Like in the other exemplary embodiments, the printed circuit board 53 is omitted and carries the sensor 51, which is disposed opposite the transmitter 52. The cabling 56 can run to the building control unit 55 in an arbitrary manner.

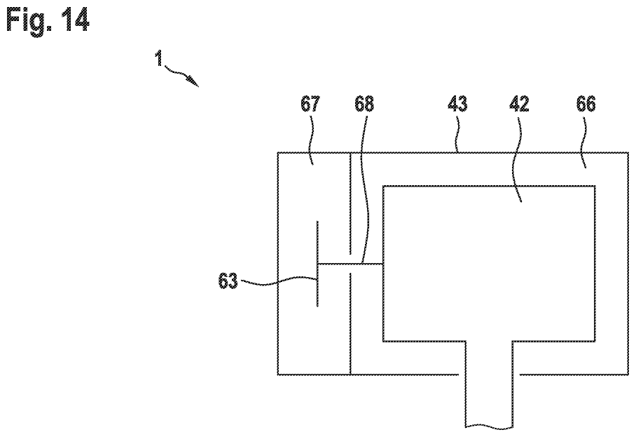

FIG. 14 purely diagrammatically shows a potential embodiment of the cross-section of the profile of the sliding rail 43. The sliding member 42 is guided in a first channel 66 of the profile. The tensioning element 63 runs in a second channel 67. Through the slot, a connection 68 connects the tensioning element 63 to the sliding member 42. In said embodiment with the two channels 66, 67, the tensioning element 63 extends well protected in its own channel.

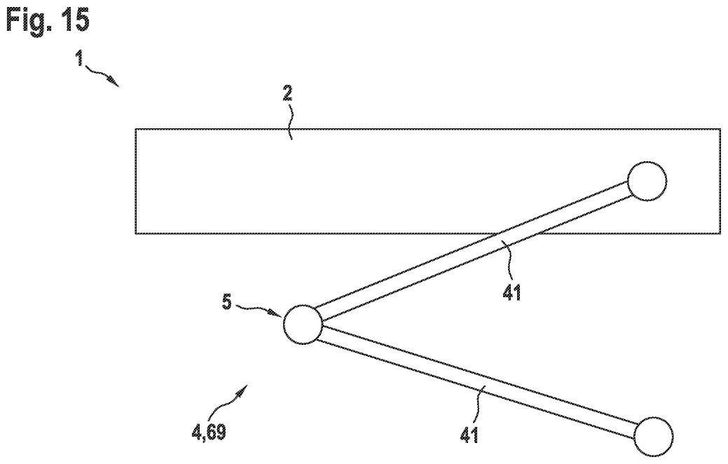

According to a fifth exemplary embodiment, FIG. 15 shows purely diagrammatically an embodiment of the door closer assembly 1 with an arm assembly 4 as a scissor arm assembly 69. In this case, two rods 41 are provided, which are rotatably connected to each other. The sensor unit 5 can be disposed at the connection of the two rods 41. In detail, the sensor unit 5 can be embodied like in the other exemplary embodiments. In this case, for example a cantilever arm 62 torque-proof connects the transmitter 52 to the one rod 41. The sensor 51, in particular on a printed circuit board 53, is located on the other rod 41.

1. A door closer assembly, comprising:
a door closer without powered drive for closing a door, wherein the door closer includes an energy accumulator, wherein the energy accumulator is chargeable by manually opening the door and wherein the energy accumulator is dischargeable by closing the door; and
a sensor unit configured for detecting an angle information with regard to an opening angle of the door.

2. The door closer assembly according to claim 1, further comprising an interface unit configured for sending the angle information to a building control unit superordinate to the door closer assembly.

3. The door closer assembly according to claim 2, further comprising a blocking device configured for holding open the door against a closing force of the door closer, wherein the interface unit is formed for receiving a closing signal form the building control unit, and wherein the interface unit is formed for controlling the blocking device upon responding to the closing signal.

4. The door closer assembly according to claim 1, wherein the sensor unit comprises a transmitter and a sensor, wherein the sensor is formed for contactlessly detecting a position of the transmitter.

5. The door closer assembly according to claim 1, wherein the door closer further comprises an output shaft, wherein the sensor unit is disposed at the output shaft for detecting the rotation of the output shaft.

6. The door closer assembly according to claim 5, wherein a first end of the output shaft is torque-proof connected to an arm assembly of the door closer assembly, and the sensor unit is disposed at a second end of the output shaft, the second end disposed opposite the first end.

7. The door closer assembly according to claim 5, wherein a first end of the output shaft is torque-proof connected to an arm assembly of the door closer assembly, and wherein the sensor unit is disposed at the connection of the output shaft to the arm assembly.

8. The door closer assembly according to claim 1, wherein the door closer further comprises an output shaft, wherein a first end of the output shaft is torque-proof connected to an arm assembly of the door closer assembly, wherein the arm assembly is formed with two rods rotatable to each other as a scissor arm assembly, and wherein the sensor unit is disposed at the connection of the two rods for detecting the rotation between the two rods.

9. The door closer assembly according to claim 1, wherein the door closer comprises an output shaft, wherein a first end of the output shaft is torque-proof connected to an arm assembly of the door closer assembly, wherein the arm assembly comprises a rod which is torque-proof connected to the output shaft, a sliding rail and a sliding member linearly guided in the sliding rail, wherein the rod is rotatably mobile connected to the sliding member.

10. The door closer assembly according to claim 9, wherein the sensor unit is disposed at the connection of the rod to the sliding member for detecting the rotation between the rod and the sliding member.

11. The door closer assembly according to claim 9, wherein the sensor unit is disposed in the sliding rail for detecting the position of the sliding member.

12. The door closer assembly according to claim 11, wherein the sensor unit comprises a tensioning element, which can be wound up and unwound from a spindle, wherein moving the sliding member makes the tensioning element windable up and unwindable, and wherein the sensor unit is formed for detecting the rotation of the spindle.

13. A method for operating a door closer assembly, in particular the door closer assembly according to claim 1, the method including the step of a sensor unit detecting angle information with regard to the opening angle of the door at a door closer without powered drive.

14. The method according to claim 13, wherein the method further includes the step of sending detected angle information to a superordinate building control unit.
